(19) United States
(12) Patent Application Publication
(10) Pub. No.: US 2004/0249802 A1
(43) Pub. Date: Dec. 9, 2004

(54) Electronic document searching apparatus

(75) Inventors: Akihiro Okumura, Saitama (JP); Hiroyuki Ohnuma, Tokyo (JP); Yoshitaka Hamaguchi, Nara (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/830,462

(22) Filed: Apr. 23, 2004

(30) Foreign Application Priority Data
Apr. 25, 2003 (JP) JP2003-122070

(51) Int. Cl. G06F 7/00

(52) U.S. Cl. 707/3

(57) ABSTRACT

An electronic document searching apparatus capable of obtaining a precise search result without securing a large storage area, comprises a link origin address holding section that searches the electronic document storage section for electronic documents including a first search character-string and holds addresses of the electronic documents as link origin addresses; a to-link-to address holding section that searches the electronic document storage section for electronic documents including a second search character-string and holds addresses of the electronic documents as to-link-to addresses; and a link relation determining section that follows link addresses indicated in an electronic document addressed by the each link origin address held, and determines, for each link address, whether at least one of the to-link-to addresses held is associated within a predetermined number of times to link sequentially.

### BACKGROUND OF THE INVENTION

1. Field of the Invention

The present invention relates to an electronic document searching apparatus that searches for a desired electronic document based on search character-strings different from each other from among a plurality of electronic documents.

2. Description of the Related Art

Electronic documents having the addresses of objects to link to indicated, that is, having a hypertext structure and being called Web pages are held in a Web server, and the Web pages can be browsed by means of a browsing apparatus, a Web browser, via a network such as the Internet connected to the Web server.

At this time, in order to browse a desired Web page from among a variety of Web pages, a user searches for a desired Web page including search character-strings specified by the user via a Web browser by means of an electronic document searching apparatus called a search engine. When by this search a Web page including the search character-strings is found out, the user can browse the desired Web page by accessing the address of the Web page by the Web browser.

Here, the Web page is divided into several Web pages for easiness for readers to read, and the divided Web pages are associated hierarchically.

An apparatus that searches such a hierarchized Web page for a desired Web page based on two or more search character-strings specified by a user is disclosed in Japanese Patent Laid-Open Publication No. 2000-259648. The search apparatus reads in to-link-to Web pages associated with a Web page including a search character-string and consolidates the divided Web pages to create a consolidated document, and acquires Web pages related to the two or more search character-strings based on the consolidated document.

However, because a conventional search apparatus needs to read in to-link-to Web pages collectively, it needs to secure a large storage area for holding a large amount of document read in collectively, which presents a problem.

Moreover, when reading in to-link-to Web pages, a conventional search apparatus reads in all the to-link-to Web pages without checking whether the Web pages to be read in are appropriate, and thus reads in a lot of Web pages different than the user wants, so that among these Web pages, Web pages that the user wants are buried, thereby not being able to obtain an appropriate search result.

### SUMMARY OF THE INVENTION

In order to solve the above problem, the present invention has the following configuration.

According to the present invention, there is provided an electronic document searching apparatus which searches an electronic document storage section holding a plurality of electronic documents indicating link addresses of objects associated thereto for desired electronic documents based on search character-strings different from each other, the apparatus comprising:

a link origin address holding section that searches the electronic document storage section for electronic documents including a first search character-string and holds addresses of the electronic documents as link origin addresses;

a to-link-to address holding section that searches the electronic document storage section for electronic documents including a second search character-string and holds addresses of the electronic documents as to-link-to addresses; and

a link relation determining section that follows link addresses indicated in an electronic document addressed by the each link origin address held in the link origin address holding section and determines, for each the link address, whether at least one of the to-link-to addresses held in the to-link-to address holding section is associated within a predetermined number of times to link sequentially.

Also, the electronic document searching apparatus may further comprise an output section that outputs addresses of electronic documents including the search character-strings as a search result based on determining results of the link relation determining section.

Also, the electronic document searching apparatus may further comprise a grouping section that divides two or more search character-strings into a group which includes at least one the first search character-string and a group which includes at least one the second search character-string.

Also, the electronic document searching may further comprise a thesaurus dictionary that has classified and systematized character-strings stored; and a search character-string adding section that, referring to the thesaurus dictionary, acquires systematized character-strings corresponding to the search character-strings as additional search character-strings and adds the additional search character-strings to the search character-strings.

Further, in the electronic document searching apparatus, the link relation determining section identifies whether each of link addresses indicated in an electronic document addressed by the each link origin address is associated internally or externally, and follows each link address found to be in an internal link relationship to determine whether at least one of the to-link-to addresses is associated within a predetermined number of times to link sequentially.

Furthermore, the electronic document searching apparatus may further comprise a link address acquisition range specifying section that specifies a range for acquiring a link address to be followed by the link relation determining section, based on a location of each search character-string in an electronic document addressed by each the link origin address.

As a case, the link address acquisition range specifying section specifies a range for acquiring a link address based on one, or a combination, of the number of tags for a structured document, and a location and the number of characters of each search character-string included in an electronic document addressed by each the link origin address.

As other case, the link address acquisition range specifying section specifies a range for acquiring a link address based on a location of each search character-string included in an electronic document addressed by each the link origin address and on the document structure of the electronic document.

Further, according to the present invention, there is provided another electronic document searching apparatus which searches an electronic document storage section holding a plurality of electronic documents indicating link addresses of objects associated thereto for desired electronic documents based on search character-strings different from each other, the apparatus comprising:

a search address holding section that searches the electronic document storage section for a plurality of electronic documents including at least one of the search character-strings and holds addresses of the electronic documents as link origin addresses; and

a link relation determining section that follows link addresses indicated in an electronic document addressed by each the link origin address held in the search address holding section within a predetermined number of times to link sequentially and determines, for each the link address, whether all the search character-strings are included in an electronic document addressed by a to-link-to address to link to and the electronic document addressed by the link origin address.

Also, the electronic document searching may further comprise an output section that outputs addresses of electronic documents including the search character-strings as a search result based on determining results of the link relation determining section.

In the electronic document searching, the link relation determining section identifies whether each of link addresses indicated in an electronic document addressed by the each link origin address is associated internally or externally, and follows each link address found to be in an internal link relationship to determine whether at least one of the to-link-to addresses is associated within a predetermined number of times to link sequentially.

Also, the electronic document searching apparatus may further comprise a link address acquisition range specifying section that specifies a range for acquiring a link address to be followed by the link relation determining section, based on a location of each search character-string in an electronic document addressed by each the link origin address.

As a case, the link address acquisition range specifying section specifies a range for acquiring a link address based on one, or a combination, of the number of tags for a structured document, and a location and the number of characters of each search character-string included in an electronic document addressed by each the link origin address.

As other case, the link address acquisition range specifying section specifies a range for acquiring a link address based on a location of each search character-string included in an electronic document addressed by each the link origin address and on the document structure of the electronic document.

The above and other objects and features of the present invention will become apparent from the following detailed description and the appended claims with reference to the accompanying drawings.

### BRIEF DESCRIPTION OF THE DRAWINGS

FIG. 1 is a block diagram of an electronic document searching apparatus of embodiment 1;

FIG. 2 is a view showing an electronic document group;

FIG. 3 is a table showing grouping of two search character-strings;

FIG. 4 is a table showing grouping of three search character-strings;

FIG. 5(a) is a view showing the contents of a link origin address holding section of embodiment 1, and FIG. 5(b) is a view showing the contents of a to-link-to address holding section of embodiment 1;

FIG. 6 is a flow chart showing the operation of the electronic document searching apparatus of embodiment 1;

FIG. 7 is a flow chart showing the operation of a link relation determining section of embodiment 1;

FIG. 8 is a view showing changes of a link management information table according to the value of a link sequence counter;

FIG. 9 is a view showing the contents of a determining result holding section of embodiment 1;

FIG. 10 is a block diagram of an electronic document searching apparatus of embodiment 2;

FIG. 11 is a view showing the contents of a thesaurus dictionary;

FIG. 12 is a flow chart showing the operation of the electronic document searching apparatus of embodiment 2;

FIG. 13 is a table showing grouping of search character-strings in embodiment 2;

FIG. 14(a) is a view showing the contents of a link origin address holding section of embodiment 2, and FIG. 14(b) is a view showing the contents of a to-link-to address holding section of embodiment 2;

FIG. 15 is a view showing changes of a link management information table according to the value of a link sequence counter in embodiment 2;

FIG. 16 is a view showing the contents of a determining result holding section of embodiment 2;

FIG. 17 is a block diagram of an electronic document searching apparatus of embodiment 3;

FIG. 18 is a view showing the source in an HTML format of electronic document 512;

FIG. 19 is a flow chart showing the operation of the electronic document searching apparatus of embodiment 3;

FIG. 20 is a flow chart showing the operation of a link relation determining section of embodiment 3;

FIG. 21 is a view showing changes of a link management information table according to the value of a link sequence counter in embodiment 3;

FIG. 22 is a view showing the contents of a determining result holding section of embodiment 3;

FIG. 23 is a block diagram of an electronic document searching apparatus of embodiment 4;

FIG. 24 is a flow chart showing the operation of the electronic document searching apparatus of embodiment 4;

FIG. 25 is a view showing the contents of a search result holding section of embodiment 4;

FIG. 26 is a flow chart showing the operation of a link relation determining section of embodiment 4;

FIG. 27 is a view showing changes of a link management information table according to the value of a link sequence counter in embodiment 4; and

FIG. 28 is a view showing the contents of a determining result holding section of embodiment 4.

### DETAILED DESCRIPTION OF THE PREFERRED EMBODIMENT

Embodiment of the present invention will be described in detail below.

### Embodiment 1

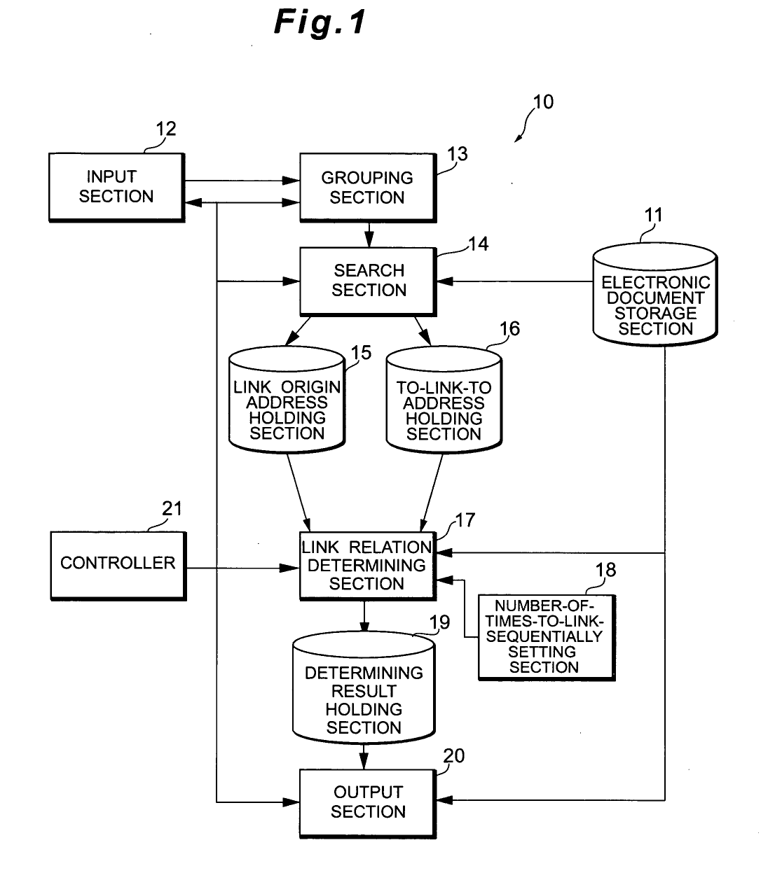

An electronic document searching apparatus 10 of the present invention, as shown in FIG. 1, comprises an electronic document storage section 11 that holds beforehand a plurality of electronic documents having the link addresses of associated objects indicated; an input section 12 for acquiring search character-strings from a user; a grouping section 13 that divides two or more search character-strings acquired by the input section 12 into two groups; a search section 14 that, for each group formed by the grouping section 13, searches the electronic document storage section 11 for electronic documents including the search character-strings thereof; a link origin address holding section 15 that holds the addresses of electronic documents including the search character-strings of one group as link origin addresses based on the search results of the search section 14; a to-link-to address holding section 16 that holds the addresses of electronic documents including the search character-strings of the other group as to-link-to addresses; a link relation determining section 17 that follows link addresses indicated in electronic documents addressed by the link origin addresses and determines, for each link address, whether at least one of the to-link-to addresses is associated within a predetermined number of times to link sequentially; a number-of-times-to-link-sequentially setting section 18 that sets the predetermined number of times to link sequentially; a determining result holding section 19 that holds determining results of the link relation determining section 17; an output section 20 that outputs the determining results held in the determining result holding section 19; and a controller 21 that controls each of the above sections.

The electronic document storage section 11 holds beforehand a plurality of hyperlink-structured electronic documents being called Web pages and having the addresses of associated objects indicated. The electronic document storage section 11 is provided in a storage apparatus called a hard disk provided in the electronic document searching apparatus 10, or alternatively configured to be connected thereto via a transmission path such as the Internet. In the latter case, the electronic document storage section 11 is incorporated in a known Web server, which provides Web pages to a client according to the requests from the client. Here, the client is the electronic document searching apparatus 10.

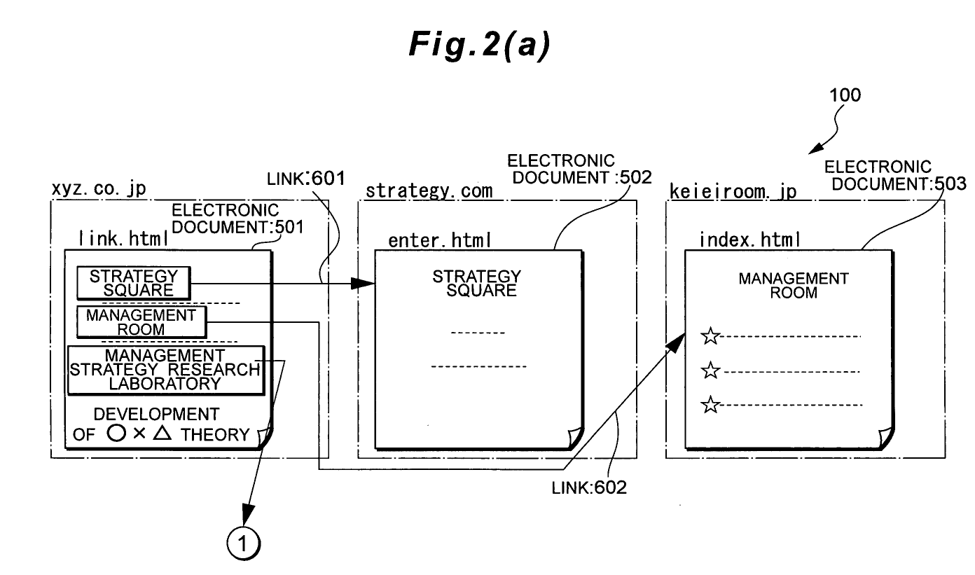

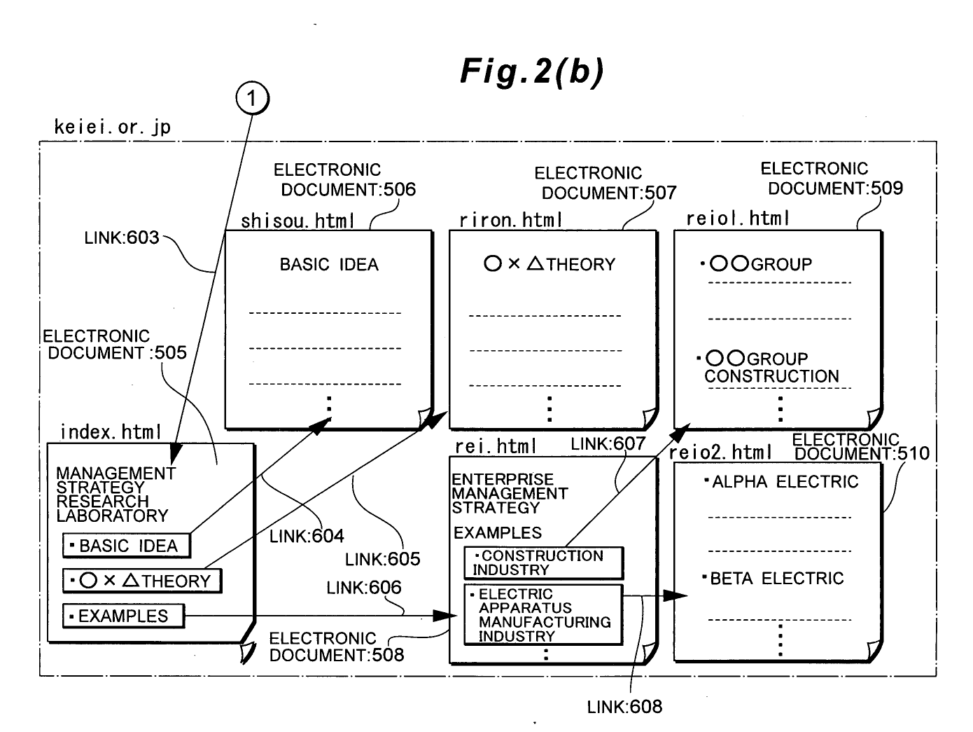

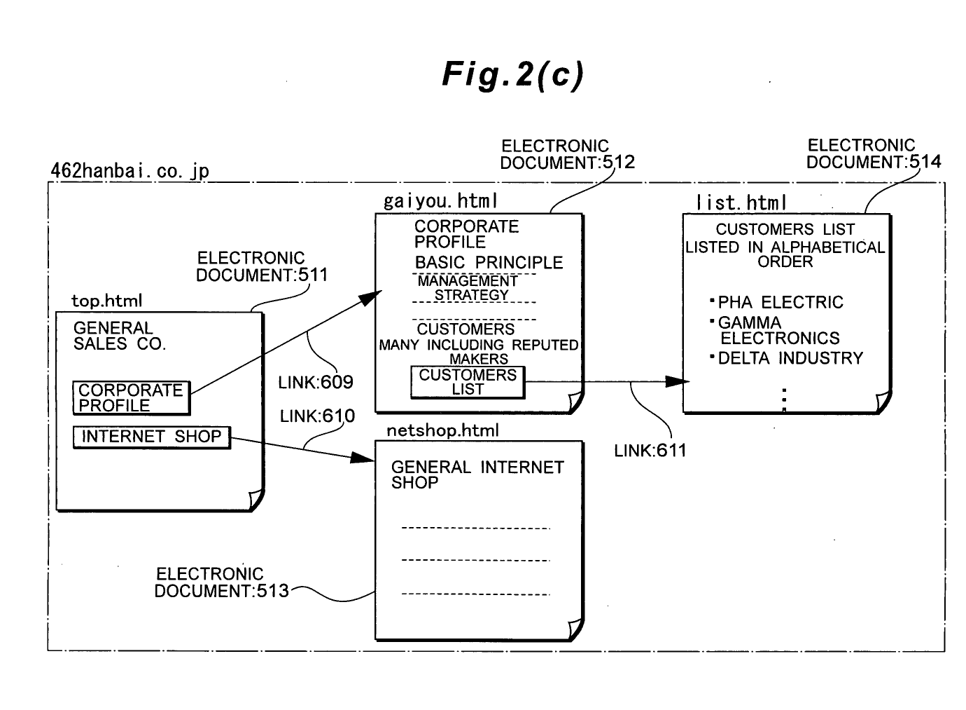

FIG. 2 shows an example of the plurality of electronic documents held by the electronic document storage section 11 (hereinafter, called an electronic document group).

An electronic document group 100, as shown in FIG. 2, is a collective entity of Web sites having respective addresses such as xyz.co.jp, strategy.com, keieiroom.jp, keiei.or.jp, and 462hanbai.co.jp, the Web sites being each encircled by a broken dotted line. Each Web site is so structured as to have at least one electronic document containing hyperlink text. For example, the Web site whose address is xyz.co.jp is structured with an electronic document having an address “xyz.co.jp/link.html” and others. In FIG. 2, only “link.html” is shown for the sake of convenience, and the electronic document having the address is encircled as a document 501 by a solid line.

The character-strings in the solid line represent the contents of the electronic document. For example, the contents of the document 501 are as follows: “Link List”, “●Strategy Square”, (omitted), “574 Management Room”, (omitted), “●Management Strategy Research Laboratory”, “development of O×Δ theory”, and “rich in examples”.

The solid arrows from the document 501 indicate objects to link to. For example, the electronic document 501 having the address “link.html” links to strategy.com/enter.html, keieiroom.jp/index.html, and keiei.or.jp/index.html, which arrows are indicated respectively as links 601, 602, and 603 in FIG. 2.

A Web site having the address keiei.or.jp includes an electronic document 505 having the address index.html, and the electronic document 505 includes electronic documents 506, 507, and 508 having respective addresses shisou.html, riron.html, and rei.html. The electronic document 508 is so structured as to include electronic documents 509 and 510 having respective addresses rei01.html and rei02.html. The links from electronic document 505 to electronic document 506, to electronic document 507, and to electronic document 508 are indicated respectively as links 604, 605, and 606 in FIG. 2. The links from electronic document 508 to electronic document 509 and to electronic document 510 are indicated respectively as links 607 and 608 in FIG. 2.

Because the links 604, 605, 606, 607 and 608 are links within the Web site having the address keiei.or.jp, these links are each called an internal link hereinafter. Meanwhile, the link from the Web site having the address xyz.co.jp to the electronic document 505 having the address index.html in the another Web site having the address keiei.or.jp is called an external link hereinafter because of being a link between different Web sites.

Moreover, while the number of times to link sequentially is one each for the link from the electronic document 505 to the electronic document 508 and the link from the electronic document 508 to the electronic document 509, the number of times to link sequentially is two for the link from the electronic document 505 up to the electronic document 509. Based on this number of times to link sequentially, the link relation determining section 17 determines the association of each electronic document as explained later.

The Web site having the address 462hanbai.co.jp included in the electronic document group 100 includes an electronic document 511 having an address top.html, and the electronic document 511 is associated with electronic documents 512 and 513 having respective addresses gaiyou.html and netshop.html in the lower layer. The electronic document 512 is associated with an electronic document 514 having an address list.html in the lower layer. The links from electronic document 511 to electronic document 513 and to electronic document 512 are indicated respectively as links 610 and 609. The link from electronic document 512 to electronic document 514 is indicated as link 611.

The input section 12 acquires search character-strings from a user through an input terminal such as a keyboard. The search character-string acquired by the input section 12 is a word, a phrase, or a sentence, depending on the function of the search section 14 explained later. The input section 12 acquires at least two search character-strings from a user.

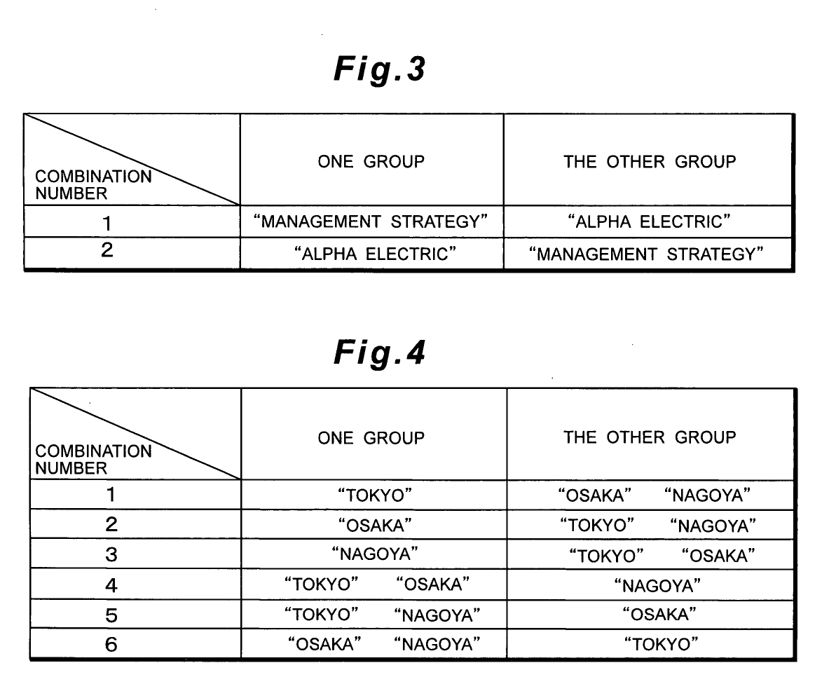

The grouping section 13 divides two or more search character-strings acquired by the input section 12 into two groups. For example, when search character-strings acquired by the input section 12 are “management strategy” and “Alpha Electric”, as shown in FIG. 3, a first combination is such that one group is formed of “management strategy” and the other group is formed of “Alpha Electric”, and a second combination is such that the one group is formed of “Alpha Electric” and the other group is formed of “management strategy”.

When the input section 12 acquires three or more search character-strings, for example, “Tokyo”, “Osaka”, and “Nagoya”, as shown in FIG. 4, the grouping section 13 groups such that one group is formed of “Tokyo”, “Osaka”, “Nagoya”, “Tokyo” and “Osaka”, “Tokyo” and “Nagoya”, or “Nagoya” and “Osaka” in six different ways and the other group is formed accordingly corresponding to the six ways.

As described above, the grouping section 13 produces all possible combinations for two groups such that search character-strings included in one group are different from ones in the other group.

For each of the first and second combinations in the grouping shown in FIG. 3, the search section 14 searches for electronic documents each including all search character-strings thereof for each group, according to a known method.

For example, the search section 14 searches the electronic document group 100 held in the electronic document storage section 11 for electronic documents each including “management strategy” of the one group of the first combination shown in FIG. 3, and thus acquires, as link origin addresses, the addresses of electronic documents including “management strategy”, namely, electronic documents 501, 505, 508, and 512 in FIG. 2.

Likewise, the search section 14 searches the electronic document storage section 11 for electronic documents including “Alpha Electric” of the other group of the first combination, and thus acquires, as to-link-to addresses, the addresses of electronic documents 510 and 514 in FIG. 2. Also for the second combination, the above search is performed to acquire link origin addresses and to-link-to addresses.

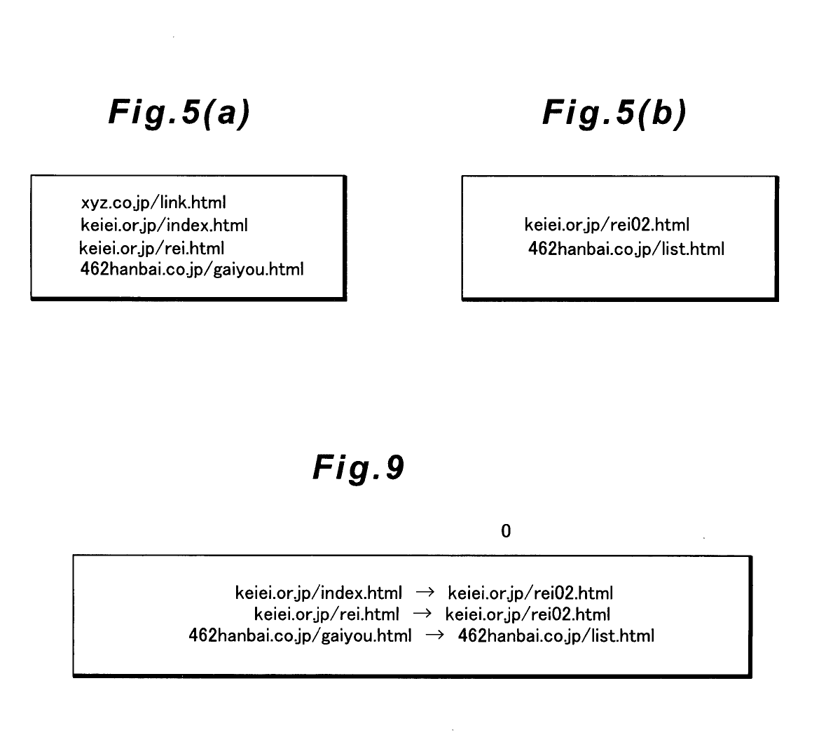

The acquired link origin addresses and to-link-to addresses are, as shown in FIG. 5, held respectively in the link origin address holding section 15 and the to-link-to address holding section 16 on a per group basis.

The link relation determining section 17 follows link addresses of internal links indicated in the electronic documents addressed by the link origin addresses held in the link origin address holding section 15, and determines, for each link address, whether at least one of the to-link-to addresses held in the to-link-to address holding section 16 is associated within the number of times to link sequentially set by the number-of-times-to-link-sequentially setting section 18.

The number-of-times-to-link-sequentially setting section 18 may have a function of holding a predetermined number of times to link sequentially beforehand instead of the function of accepting the setting of the number of times to link sequentially from a user. In view of a later-shown flow chart illustrating the operation of the electronic document searching apparatus 10, in the present embodiment the number of times to link sequentially is set to zero or greater. By setting the number of times to link sequentially as needed, an appropriate search result can be obtained with suppressing the increase of processing time.

The determining result holding section 19 holds the addresses of electronic documents associated within the set number of times to link sequentially based on the determining results of the link relation determining section 17. Both of the to-link-to addresses and the link origin addresses associated within the predetermined number of times to link sequentially are held in the determining result holding section 19.

The output section 20 is a display apparatus for displaying addresses held in the determining result holding section 19 for a user and acquires electronic documents addressed by the addresses held in the determining result holding section 19 as needed to display the contents of the electronic documents.

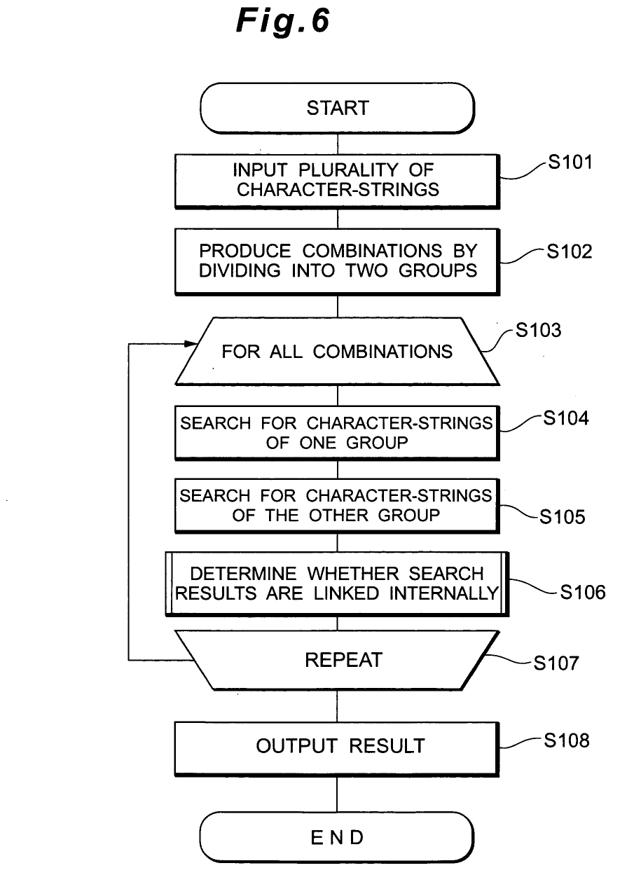

Next, the operation of the electronic document searching apparatus 10 of the present invention will be explained with reference to the flow chart of FIG. 6.

The input section 12 acquires search character-strings different from each other entered by a user (step S101).

When the two or more search character-strings acquired have been sent to the grouping section 13, the grouping section 13 divides the search character-strings into two groups (step S102). The following three steps are executed for all combinations produced by the grouping (step S103).

After the grouping of the search character-strings, the search section 14 acquires electronic documents including the search character-string of the one group from the electronic document storage section 11 (step S104). The addresses of the acquired electronic documents are stored as link origin addresses in the link origin address holding section 15. For example, as shown in FIG. 5(a) for the combination numbered 1 in FIG. 3, the addresses of electronic documents 501, 505, 508, and 512 including the search character-string “management strategy” are stored as link origin addresses in the link origin address holding section 15.

Next, the search section 14 acquires electronic documents including the search character-string of the other group from the electronic document storage section 11 (step S101). The addresses of the acquired electronic documents are stored as to-link-to addresses in the to-link-to address holding section 16. As shown in FIG. 5(b) for the combination numbered 1 in FIG. 3, the addresses of electronic documents 510 and 514 including the search character-string “Alpha Electric” are stored as to-link-to addresses in the to-link-to address holding section 16.

The link relation determining section 17 follows link addresses of internal links indicated in the electronic documents addressed by the link origin addresses held in the link origin address holding section 15, and determines, for each link address, whether at least one of the to-link-to addresses held in the to-link-to address holding section 16 is associated within the number of times to link sequentially set by the number-of-times-to-link-sequentially setting section 18 (step S106). The addresses of electronic documents associated by this determination within the set number of times to link sequentially, namely, the to-link-to addresses and the link origin addresses associated within the predetermined number of times to link sequentially are stored in the determining result holding section 19.

The controller 21 determines whether the determination is completed of whether the electronic documents are associated within the set number of times to link sequentially for all numbered combinations produced by the grouping by the grouping section 13. When the controller 21 determines that the determination is not completed of whether the electronic documents are associated within the set number of times to link sequentially for all numbered combinations, the processes of the above step S103 and later are repeated (step S107).

On the other hand, when the controller 21 determines that the determination is completed of whether the electronic documents are associated within the set number of times to link sequentially for all numbered combinations, the link origin addresses and to-link-to addresses held in the determining result holding section 19 are output by the output section 20 (step S108).

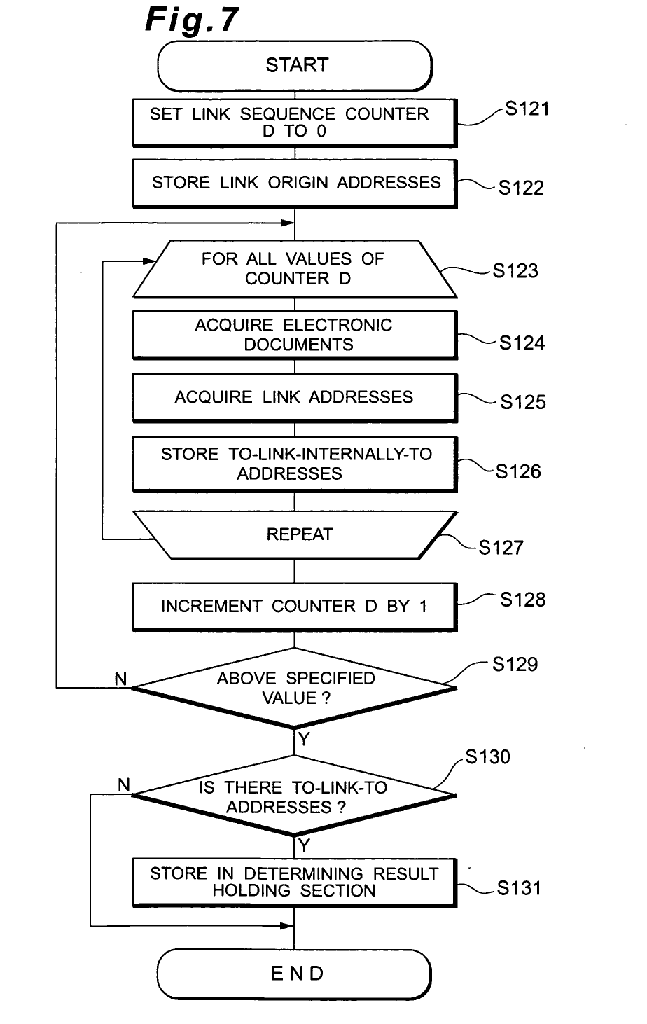

Next, the operation of the link relation determining section 17 will be explained in detail with reference to the flow chart of FIG. 7. For the case where the link origin addresses shown in FIG. 5(a) are held in the link origin address holding section 15, the to-link-to addresses shown in FIG. 5(b) are held in the to-link-to address holding section 16, and the number-of-times-to-link-sequentially setting section 18 has set the predetermined number of times to link sequentially at two, the operation of the link relation determining section 17 will be explained.

The link relation determining section 17 comprises a link-sequence counter for counting the number of sequential links and a link management information table.

The link relation determining section 17 initially sets the link-sequence counter to zero (step S121).

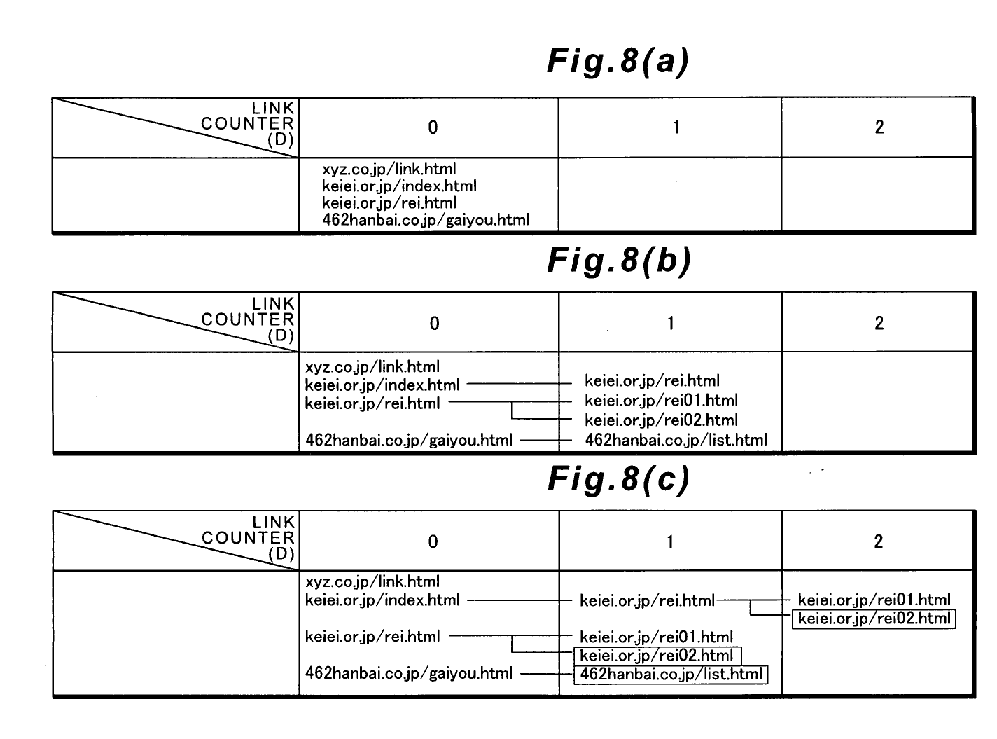

Next, the link origin addresses held in the link origin address holding section 15 are stored in the link management information table (step S122). The contents of the link management information table having the link origin addresses stored are shown in FIG. 8(a).

The next three steps are repeated for each of the link origin addresses stored in the link management information table (step S123).

The electronic document addressed by a link origin address is acquired from the electronic document storage section 11 (step S124).

The contents of the hypertext of the acquired electronic document are checked to acquire the link addresses of internal links as mentioned above (step S125).

By acquiring the link addresses of the internal links, link addresses not directly related to search character-strings such as link lists that happen to include one or more of the search character-strings can be excluded from among objects to be searched.

Based on the acquired link addresses, the link addresses of the electronic documents associated with the electronic document are stored in the column corresponding to the link-sequence counter's next value of the link management information table as shown in FIG. 8(b) (step S126).

The above processes are repeated for all the addresses stored in the column corresponding to the link-sequence counter's current value of the link management information table (step S127).

After the above processes are completed for all the addresses, the link-sequence counter is incremented by one (step S128).

It is determined whether the value of the incremented link-sequence counter is above the number set by the number-of-times-to-link-sequentially setting section 18 (step S129). When it is determined that the value of the link-sequence counter is above the number set by the number-of-times-to-link-sequentially setting section 18, the next process is performed. On the other hand, if the value of the link-sequence counter is not above the set number of times to link sequentially, that is, two in the present embodiment, the above step S123 and later are repeated.

The above steps S123 through S129 are repeated in that order. As the link-sequence counter increases from 0 to 1 to 2, the contents of the link management information table change, which changes are shown in FIGS. 8(a), 8(b), and 8(c).

When the value of the link-sequence counter becomes greater than the value set by the number-of-times-to-link-sequentially setting section 18, for each value of the link-sequence counter, for each of the addresses stored in the link management information table, it is determined whether it matches one of the addresses shown in FIG. 5(b) held in the to-link-to address holding section 16 (step S130). In FIGS. 8(b) and 8(c), the addresses that match those held in the to-link-to address holding section 16 are encircled by squares respectively. When the addresses stored in the link management information table include the addresses held in the to-link-to address holding section 16, that is, when addresses stored in the link management information table and the to-link-to addresses match, pairs of a matching to-link-to address and link origin address are stored in the determining result holding section 19 as shown in FIG. 9 (step S131).

The pairs of a link origin address and to-link-to address held in the determining result holding section 19 are displayed by the output section 20 as a display apparatus for the user.

If a to-link-to address and link origin address of a pair are the same, the output section 20 displays only the same address.

As described above, according to the electronic document searching apparatus 10 of embodiment 1, for a Web site that is so structured that its electronic document is divided into several electronic documents for the sake of convenience, by checking whether the electronic documents each including one or more of the search character-strings are associated within the predetermined number of times to link sequentially, electronic documents having a high association degree are acquired as a result of the search. Thus, desired electronic documents related to two or more search character-strings can be obtained appropriately.

Moreover, according to the electronic document searching apparatus 10 of embodiment 1, the association of the electronic documents each including one or more of the search character-strings is checked only for the internal links. Thus, for example, link lists, which are not directly related to the search character-strings, can be excluded from among objects to be searched.

Furthermore, according to the electronic document searching apparatus 10 of embodiment 1, no need exists for collectively reading in all electronic documents addressed by the link addresses indicated in a Web page and storing a large amount of electronic document. Therefore, the usage of the storage area of the electronic document searching apparatus 10 can be reduced.

### Embodiment 2

Next, an electronic document searching apparatus 30 will be described which, referring to a thesaurus dictionary storing classified and systematized character-strings, adds character-strings corresponding to the systematization of search character-strings to the search character-strings and searches for desired electronic documents.

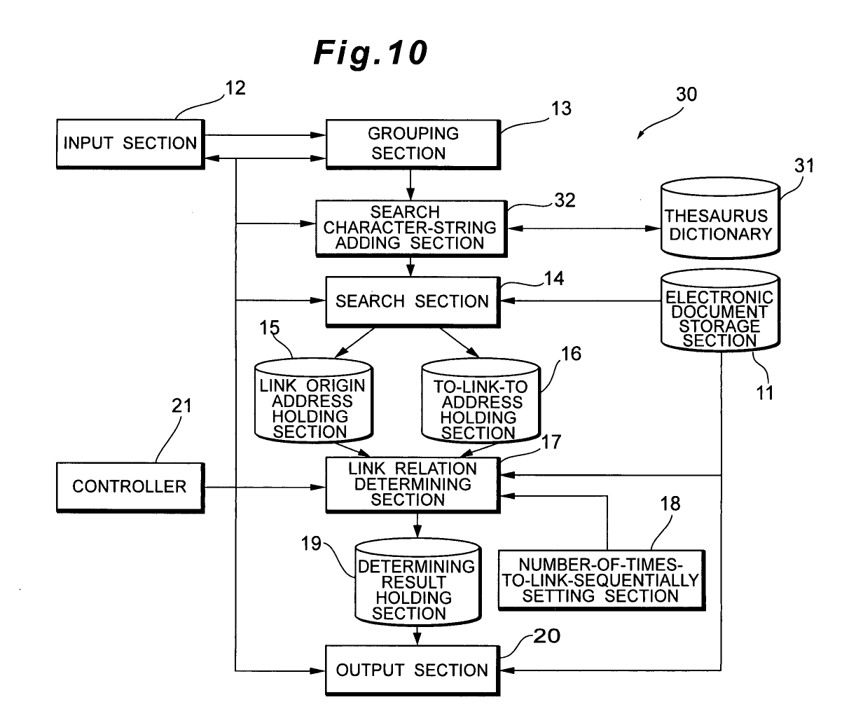

The electronic document searching apparatus 30 of embodiment 2, as shown in FIG. 10, as in embodiment 1, comprises the electronic document storage section 11; the input section 12; the grouping section 13; the search section 14; the link origin address holding section 15; the to-link-to address holding section 16; the number-of-times-to-link-sequentially setting section 18; the determining result holding section 19; the output section 20; the controller 21; and a link relation determining section 17′ instead of the link relation determining section 17 of embodiment 1. The electronic document searching apparatus 30 further comprises a thesaurus dictionary 31 and a search character-string adding section 32 that, referring to the thesaurus dictionary 31, adds systematized character-strings corresponding to search character-strings entered via the input section 12 to the search character-strings.

While the link relation determining section 17 of embodiment 1 follows the link addresses of internal links, the link relation determining section 17′ of embodiment 2, when following link addresses indicated in the electronic document addressed by a link origin address, follows the link addresses of external links as well as those of internal links to determine whether at least one to-link-to address is associated, for each link address.

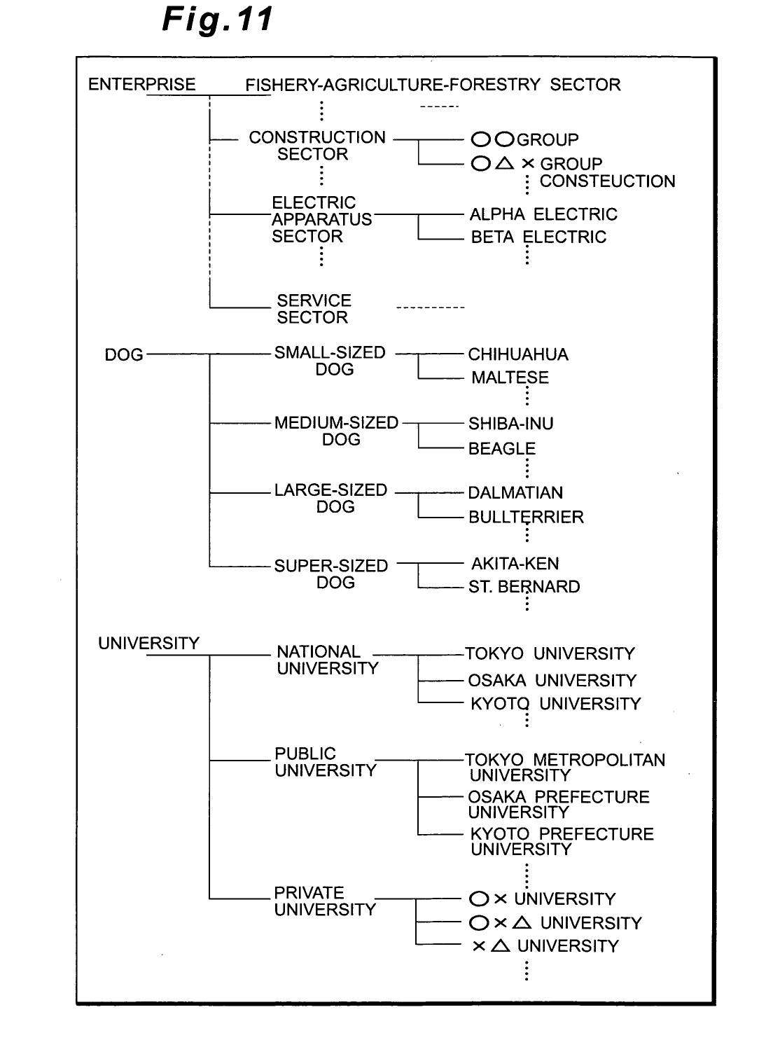

The thesaurus dictionary 31 has arbitrary character-strings systematized into layers as shown in FIG. 11. Present in the lower layer of enterprise, for example, are fishery-agriculture-forestry sector, construction sector, electric apparatus sector, service sector, and the like, and under the electric apparatus sector, company names such as Alpha Electric and Beta Electric are present.

Besides enterprise, classified in the lower layer of dog, for example, are small-sized dog, medium-sized dog, large-sized dog, and super-sized dog. As kinds of dogs, Chihuahua, Maltese, and the like are shown in the lower layer of the small-sized dog; Shiba-inu, beagle, and the like in the lower layer of the medium-sized dog; Dalmatian, bullterrier, and the like in the lower layer of the large-sized dog; and Akita-ken, St. Bernard, and the like in the lower layer of the super-sized dog.

Classified for university are national university, public university, and private university, and university names are shown in the lower layer thereof.

Referring to the thesaurus dictionary 31, systematized character-strings corresponding to search character-strings are acquired as additional search character-strings, and the acquired character-strings are added to the search character-strings. For example, when one of search character-strings is “Alpha Electric”, its broad term “electric apparatus” is acquired as an additional search character-string and the acquired additional search character-string is added to the search character-strings. Hence, “electric apparatus” is put together with “Alpha Electric”, and using these character-strings as search character-strings, the same processes as in embodiment 1 described previously are performed.

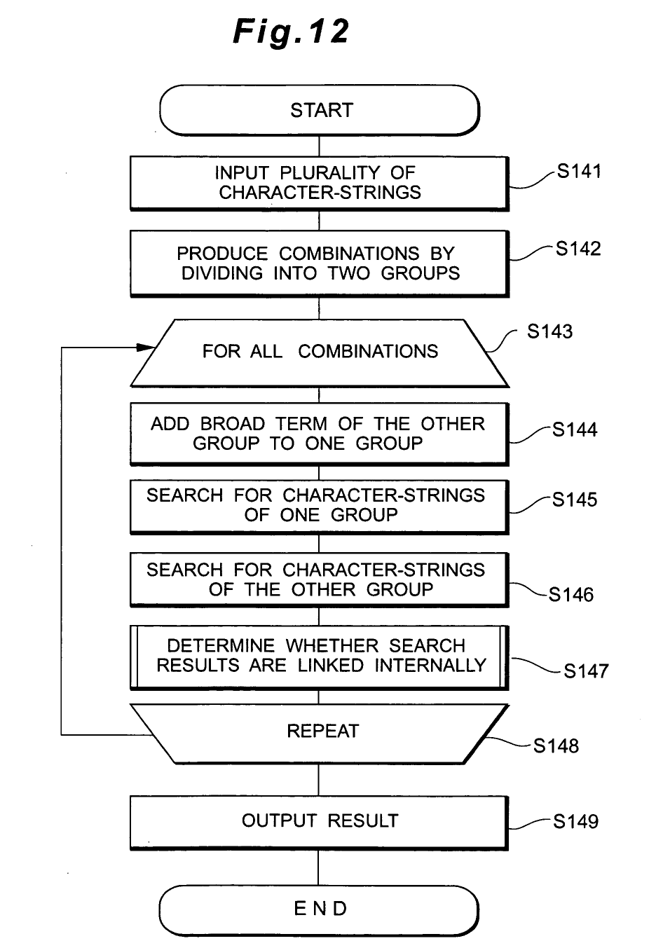

Next, the operation of the electronic document searching apparatus 30 will be explained with reference to the flow chart of FIG. 12.

The electronic document group 100 held in the electronic document storage section 11 has the contents as shown in FIG. 2, and the thesaurus dictionary 31 has the contents as shown in FIG. 11. Under theses conditions, the input section 12 acquires “management strategy” and “Alpha Electric” as search character-strings (step S141).

When the acquired search character-strings have been sent to the grouping section 13, the grouping section 13 divides the search character-strings into two groups as shown in FIG. 3 (step S142). The following four steps are executed for all combinations produced by the grouping (step S143).

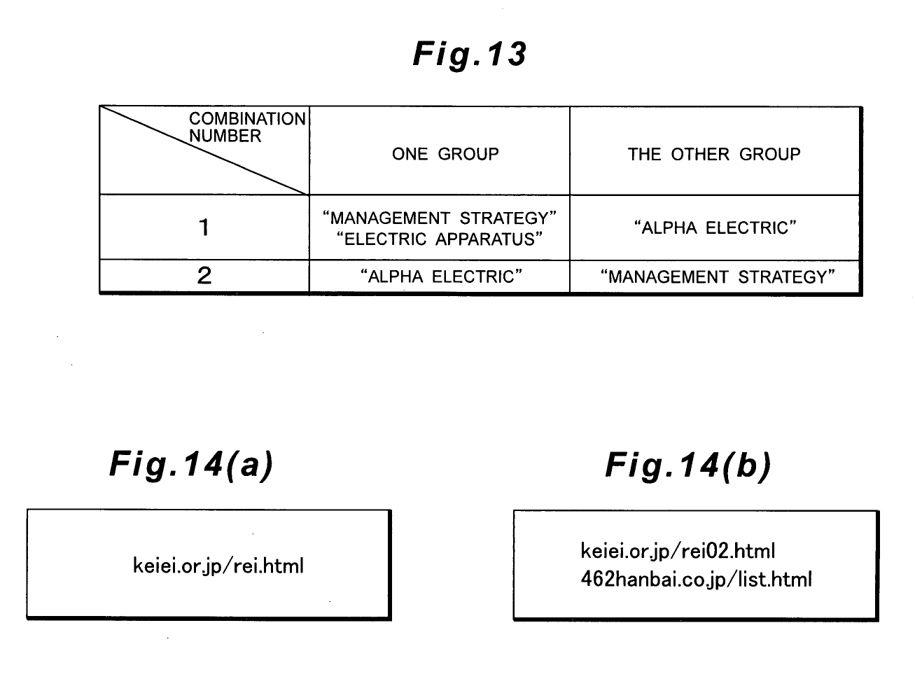

After the grouping of the search character-strings, the search character-string adding section 32, referring to the thesaurus dictionary 31, acquires “electric apparatus”, as the broad term of “Alpha Electric” of the other group in the combination numbered 1 in FIG. 3, and adds the acquired “electric apparatus” as an additional search character-string to the one group. Next, the search character-string adding section 32 searches the thesaurus dictionary 31 for a broad term of “management strategy”, but because no systematized character-string exists for “management strategy”, no additional search character-string is added. FIG. 13 shows the groups having the additional search character-string added by the search character-string adding section 32.

The search section 14 acquires electronic documents including all the search character-strings of the one group from the electronic document storage section 11 (step S144). The addresses of the acquired electronic documents are stored as link origin addresses in the link origin address holding section 15. For example, as shown in FIG. 14(a) for the combination numbered 1 in FIG. 13, the address of electronic document 508 including both of “management strategy” and “electric apparatus” is stored as a link origin address in the link origin address holding section 15.

Next, the search section 14 acquires electronic documents including all the search character-strings of the other group from the electronic document storage section 11 (step S145). The addresses of the acquired electronic documents are stored as to-link-to addresses in the to-link-to address holding section 16. As shown in FIG. 14(b) for the combination numbered 1 in FIG. 13, the addresses of electronic documents 510 and 514 including the search character-string “Alpha Electric” are stored as to-link-to addresses in the to-link-to address holding section 16.

The link relation determining section 17 follows the link addresses indicated in the electronic documents addressed by the link origin addresses held in the link origin address holding section 15 whether link addresses are of internal links or external links, and determines, for each link address, whether at least one of the to-link-to addresses held in the to-link-to address holding section 16 is associated within the number of times to link sequentially set by the number-of-times-to-link-sequentially setting section 18 (step S147).

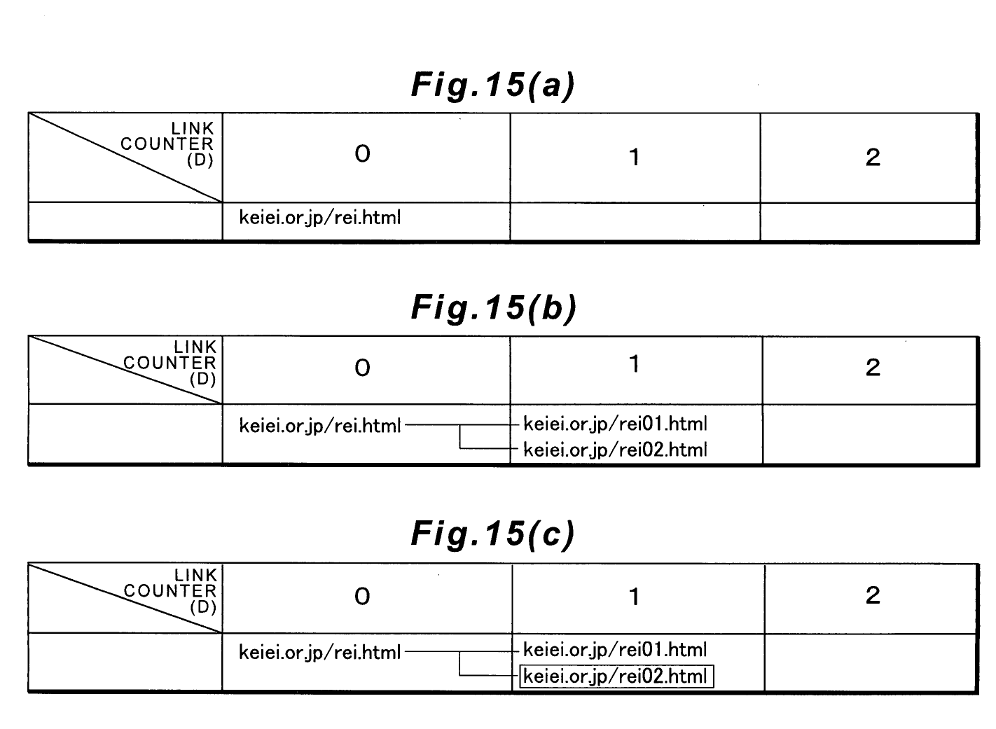

As the link-sequence counter of the link relation determining section 17′ increases from 0 to 1 to 2, the contents of the link management information table change, which changes are shown in FIGS. 15(a) to 15(c).

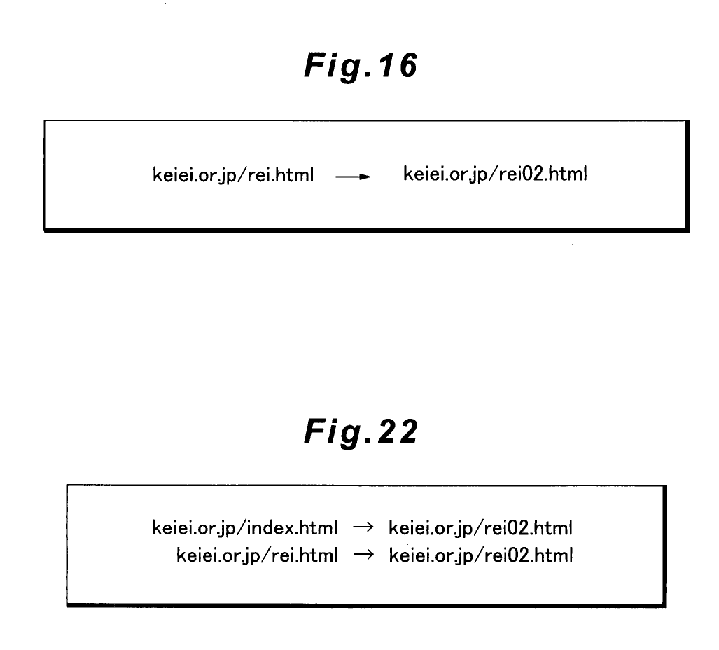

The addresses of the electronic documents associated within the set number of times to link sequentially by the link relation determining section 17′, that is, to-link-to addresses and link origin addresses associated within the predetermined number of times to link sequentially are stored in the determining result holding section 19. FIG. 16 shows the addresses of electronic documents held in the determining result holding section 19 when the value of the link sequence counter is two, as an example.

The controller 21 determines whether the determination is completed of whether the electronic documents are associated within the set number of times to link sequentially for all numbered combinations produced by the grouping by the grouping section 13. When the controller 21 determines that the determination is not completed of whether the electronic documents are associated within the set number of times to link sequentially for all numbered combinations, the processes of the above step S143 and later are repeated (step S148).

On the other hand, when the controller 21 determines that the determination is completed of whether the electronic documents are associated within the set number of times to link sequentially for all numbered combinations, the link origin addresses and to-link-to addresses held in the determining result holding section 19 are output by the output section 20 (step S149).

As described above, according to the electronic document searching apparatus 30, the search character-string adding section 32, referring to the thesaurus dictionary 31, acquires systematized character-strings corresponding to search character-strings as additional search character-strings, and adds the acquired additional search character-strings to the search character-strings. Thus, electronic documents are searched using genres that the search character-strings belong to together with the search character-strings. Hence, electronic documents of genres different than the user wants can be excluded, so that desired electronic documents related to the search character-strings can be obtained certainly.

### Embodiment 3

Next, an electronic document searching apparatus 40 will be described which comprises a link address acquisition range specifying section 41 that checks the document structure of a structured electronic document called an HTML (Hyper Text Markup Language) document and including search character-strings and that specifies a range in which link addresses to be followed by the link relation determining section are to be acquired.

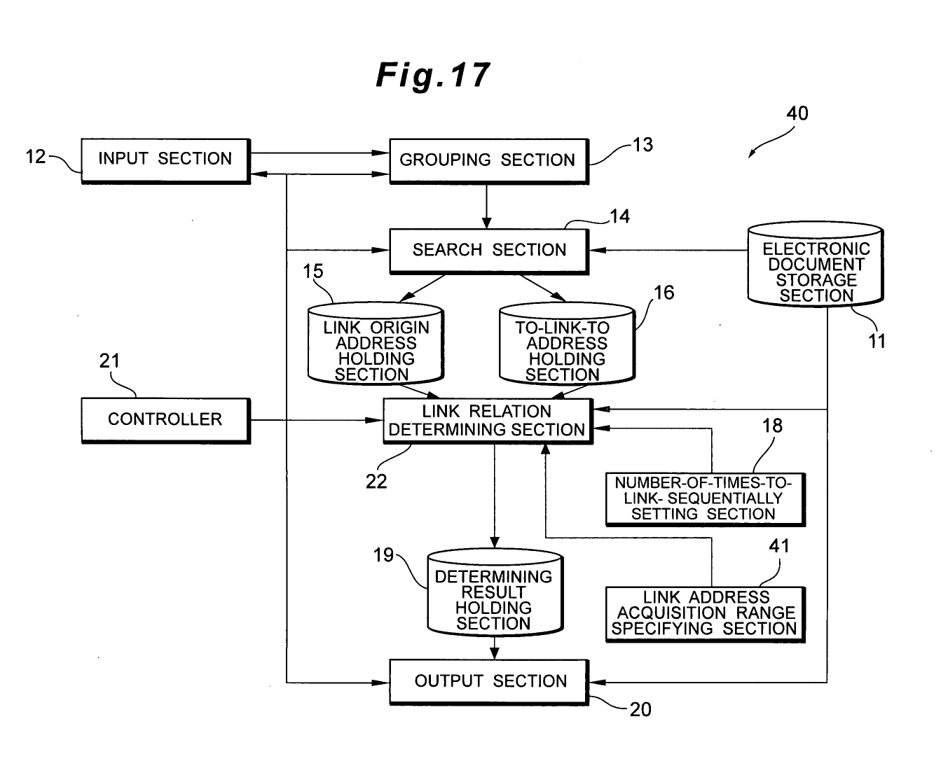

The electronic document searching apparatus 40 of embodiment 3, as shown in FIG. 17, as in embodiment 1, comprises the electronic document storage section 11; the input section 12; the grouping section 13; the search section 14; the link origin address holding section 15; the to-link-to address holding section 16; the number-of-times-to-link-sequentially setting section 18; the determining result holding section 19; the output section 20; the controller 21; and a link relation determining section 22 instead of the link relation determining section 17 of embodiment 1. The electronic document searching apparatus 40 further comprises the link address acquisition range specifying section 41.

The link address acquisition range specifying section 41, which is the feature of the present embodiment, will be described omitting a description of the same configuration as in the above embodiments.

The link address acquisition range specifying section 41 analyzes an electronic document including search character-strings and specifies a range in which link addresses are to be acquired, based on the locations in the electronic document of the search character-strings, the number of characters, the number and contents of tags of the structured document, the document structure, and the like.

The link relation determining section 22 acquires link addresses called anchors in the link address acquisition range specified by the link address acquisition range specifying section 41 and follows the acquired link addresses to determine, for each link address, whether at least one of the to-link-to addresses held in the to-link-to address holding section 16 is associated within the predetermined number of times to link sequentially.

A method for the specifying of a range in which link addresses are to be acquired is disclosed in Japanese Patent Application No. 2001-290552. According to Japanese Patent Application No. 2001-290552, first, the document structure is analyzed to obtain a basic range and checks whether a search character-string is included in the basic range.

There are a plurality of types of such basic ranges as follows.

A first basic range is a title portion (from <Title> tag to </Title> tag).

A second basic range is a heading portion (from <Hn> tag to </Hn> tag, where n≧1).

A third basic range is individual rows in a <TABLE> tag, that is, a portion from <TR> tag to </TR> tag.

A fourth basic range is a portion from <DT> tag to <DD> tag in a <DL> tag.

Portions except the above basic ranges are classified as the fifth basic range which is a delimited range in the layout when displaying a HTML structured electronic document by a browser and which is indicated by, for example, horizontal line (<HR> tag), table (<TABLE> tag), unordered or ordered list (<UL> tag, <OL> tag), definition list (<DL> tag), input form (<FORM> tag), pre-formatted text (<PRE> tag), and heading (<Hn> tag), or which is delimited by them when horizontal lines or headings are displayed, or which is delimited by it when <P> tag, <LI> tag, or “.” is present.

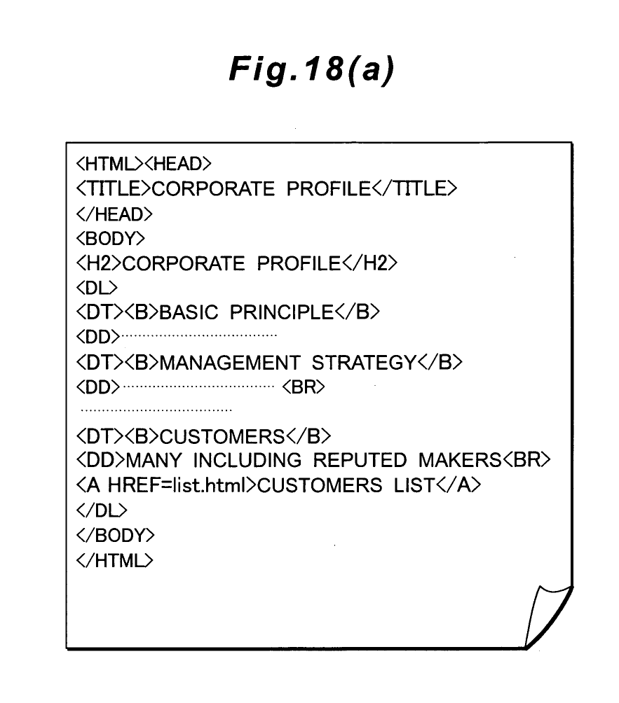

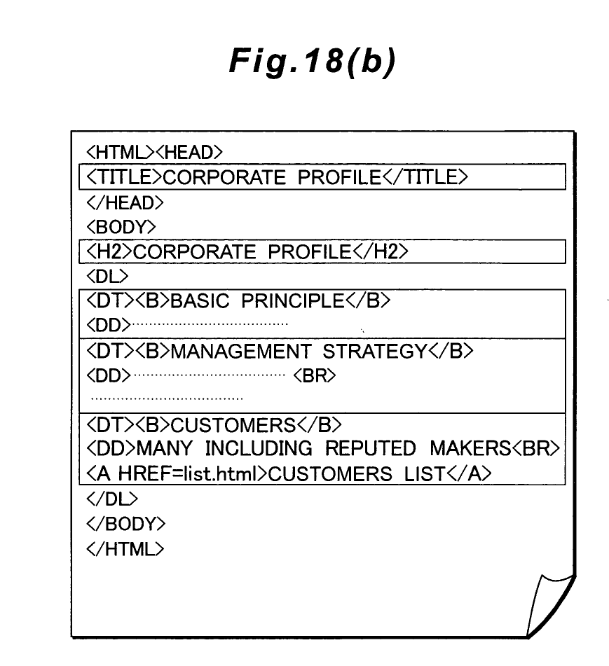

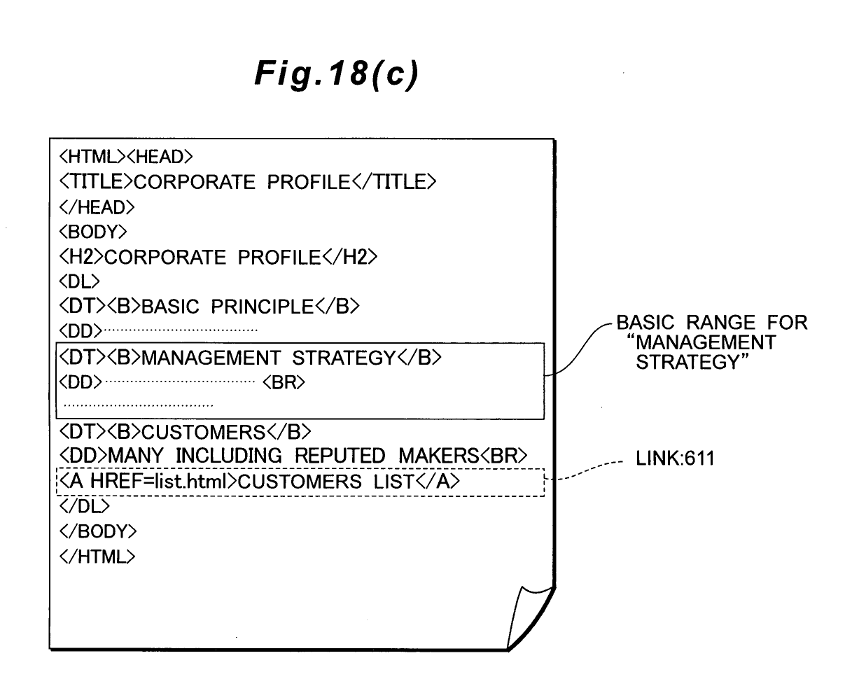

A description will be made taking electronic document 512 of FIG. 2 as an example. FIG. 18(a) shows the source in the HTML format of electronic document 512, and FIG. 18(b) shows various types of basic ranges encircled by squares in electronic document 512.

After the basic ranges are identified in electronic document 512, it is checked for each basic range whether a search character-string is included therein. According to a basic range containing a search character-string, a range for acquiring link addresses is decided.

For example, when the title portion includes a search character-string, the entire electronic document is decided to be a range for acquiring link addresses.

When the heading portion includes a search character-string, a range based on a document relationship, that is, a portion up to the next heading or a <HR> tag is decided to be a range for acquiring link addresses.

When a list-item includes a search character-string and has a nested structure in which at least one item nests, the range for acquiring link addresses includes the nesting item as well.

If a search character-string exists at a location different than mentioned above, the range for acquiring link addresses is decided to be a basic range which spreads beyond a delimiter, a period “.”, delimiting another basic range where the search character-string exists and which is delimited by another delimiter.

For electronic document 512, let “management strategy” be a search character-string. Because the search character-string is included in an item and the item has a nested structure, the link address acquisition range specifying section 41 designates the range including also the nesting items as a range for acquiring link addresses. Based on this designated acquiring range, the link relation determining section 22 acquires a link address encircled by the broken line in FIG. 18(c).

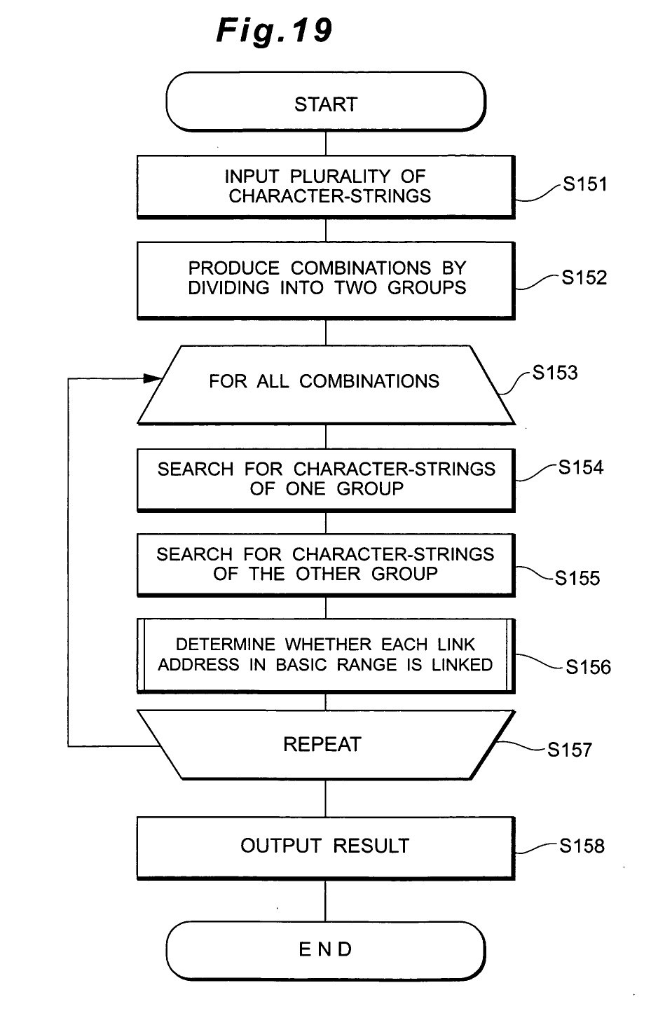

Next, the operation of the electronic document searching apparatus 40 will be explained with reference to the flow chart of FIG. 19.

The electronic document group 100 held in the electronic document storage section 11 has the contents as shown in FIG. 2. Under theses conditions, the input section 12 acquires “management strategy” and “Alpha Electric” as search character-strings (step S151).

When the search character-strings acquired have been sent to the grouping section 13, the grouping section 13 divides the search character-strings into two groups as shown in FIG. 3 (step S152). The following three steps are executed for all combinations produced by the grouping (step S153).

The search section 14 acquires electronic documents including the search character-string of the one group from the electronic document storage section 11 (step S154). The addresses of the acquired electronic documents are stored as link origin addresses in the link origin address holding section 15.

Next, the search section 14 acquires electronic documents including the search character-string of the other group from the electronic document storage section 11 (step S155). The addresses of the acquired electronic documents are stored as to-link-to addresses in the to-link-to address holding section 16.

The link relation determining section 22 acquires link addresses indicated in the electronic documents addressed by the link origin addresses held in the link origin address holding section 15 from the range specified by the link address acquisition range specifying section 41, and follows the acquired link addresses and determines, for each link address, whether at least one of the to-link-to addresses held in the to-link-to address holding section 16 is associated within the number of times to link sequentially set by the number-of-times-to-link-sequentially setting section 18 (step S156).

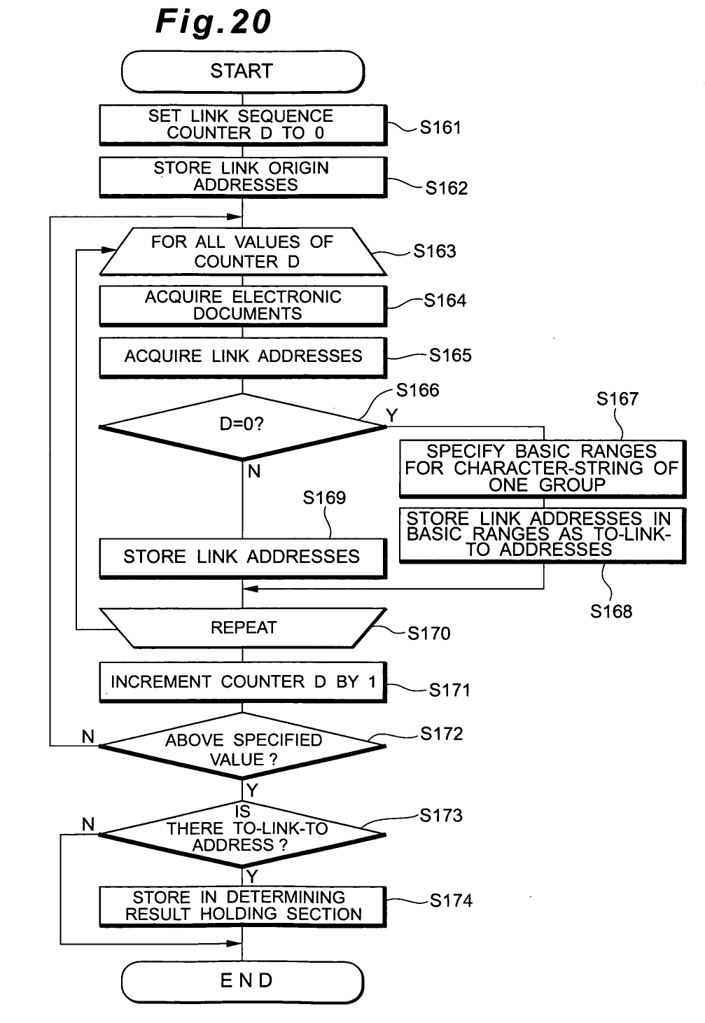

Next, the operation of the link relation determining section 22 will be explained in detail with reference to the flow chart of FIG. 20. The link relation determining section 22 comprises a link-sequence counter and a link management information table as in the above embodiments, and the number-of-times-to-link-sequentially setting section 18 has set the predetermined number of times to link sequentially at two.

The link relation determining section 22 initially sets the link-sequence counter D to zero (step S161). Next, the link origin addresses held in the link origin address holding section 15 are stored in the link management information table (step S162).

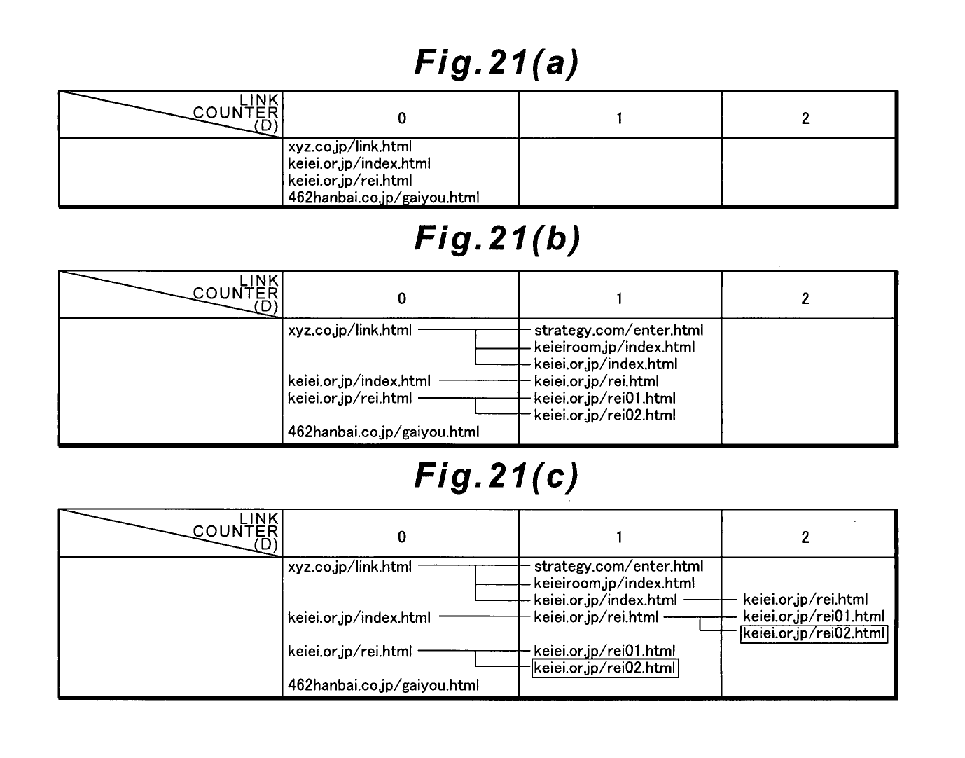

The contents of the link management information table having the link origin addresses for the combination numbered 1 in FIG. 3 stored are shown in FIG. 21(a).

The next four or five steps are repeated for each of the link origin addresses stored in the link management information table (step S163).

The electronic document addressed by a link origin address is acquired from the electronic document storage section 11 (step S164). The acquired electronic document is analyzed to acquire the link addresses indicated therein (step S165).

It is determined whether the value of the link-sequence counter is zero (step S166).

When the value of the link-sequence counter is zero, the link address acquisition range specifying section 41, according to instructions, analyzes electronic documents including the search character-string of the one group, and specifies a range for acquiring link addresses based on the location of the search character-string, the number of characters, the number and contents of tags of the structured document, the document structure, and the like (step S167). Information indicating the specified range is sent to the link relation determining section 22.

Next, the link relation determining section 22 acquires link addresses associated with the electronic document within the specified range, and the acquired link addresses are stored in the column corresponding to the link-sequence counter's next value of the link management information table as shown in FIG. 21(b) (step S168).

When the value of the link-sequence counter is not zero, the link relation determining section 22 acquires link addresses associated with the electronic document, and all the acquired link addresses are stored in the column corresponding to the link-sequence counter's next value of the link management information table (step S169).

The above processes are repeated for all the addresses stored in the column corresponding to the link-sequence counter's current value of the link management information table (step S170).

After the above processes are completed for all the addresses, the link-sequence counter is incremented by one (step S171).

It is determined whether the value of the incremented link-sequence counter is above the number set by the number-of-times-to-link-sequentially setting section 18 (step S172). When it is determined that the value of the link-sequence counter is above the number set by the number-of-times-to-link-sequentially setting section 18, the next process is performed. On the other hand, if the value of the link-sequence counter is not above the set number of times to link sequentially, that is, two in the present embodiment, the above step S163 and later are repeated.

The above steps S163 through S172 are repeated. As the link-sequence counter increases from 0 to 1 to 2, the contents of the link management information table change, which changes are shown in FIGS. 21(a), 21(b), and 21(c).

When the value of the incremented link-sequence counter becomes greater than the value set by the number-of-times-to-link-sequentially setting section 18, for each of the addresses stored in the link management information table, it is determined whether it matches one of the addresses held in the to-link-to address holding section 16, that is, whether each to-link-to address is stored in the link management information table (step S173). In FIG. 21(c), the addresses stored in the link management information table that match the to-link-to addresses held in the to-link-to address holding section 16 are encircled by squares respectively.

When the addresses stored in the link management information table include the addresses held in the to-link-to address holding section 16, that is, when addresses stored in the link management information table and the to-link-to addresses match, pairs of a matching to-link-to address and link origin address are stored in the determining result holding section 19 as shown in FIG. 22 (step S174).

Referring back to the flow chart of FIG. 19, the controller 21 determines whether the determination is completed of whether the electronic documents are associated within the set number of times to link sequentially for all numbered combinations produced by the grouping by the grouping section 13. When the controller 21 determines that the determination is not completed of whether the electronic documents are associated within the set number of times to link sequentially for all numbered combinations, the processes of the above step S153 and later are repeated (step S157).

On the other hand, when the controller 21 determines that the determination is completed of whether the electronic documents are associated within the set number of times to link sequentially for all numbered combinations, the link origin addresses and to-link-to addresses held in the determining result holding section 19 are output by the output section 20 (step S158).

As described above, the electronic document searching apparatus 40 of embodiment 3 analyzes an electronic document including search character-strings and specifies a range in which link addresses are to be acquired, based on the location in the electronic document of the search character-string, the number of characters, the number and contents of tags of the structured document, the document structure, and the like. Then, link addresses are acquired within the specified search range. Thus, in FIG. 2, for example, a pair of addresses of electronic documents 512 and 514, which include the search characters “management strategy” and “Alpha Electric” respectively but are not directly related to the character-strings, can be excluded from the search result, and hence the precise search result can be obtained.

### Embodiment 4

While two or more character-strings entered are grouped in embodiment 3, an OR-type search section 51 of embodiment 4, instead of the grouping, searches collectively for electronic documents including at least one or more of character-strings. An electronic document searching apparatus 50 will be described which comprises the OR-type search section 51 and a search result holding section 52 holding the search result of the OR-type search section 51.

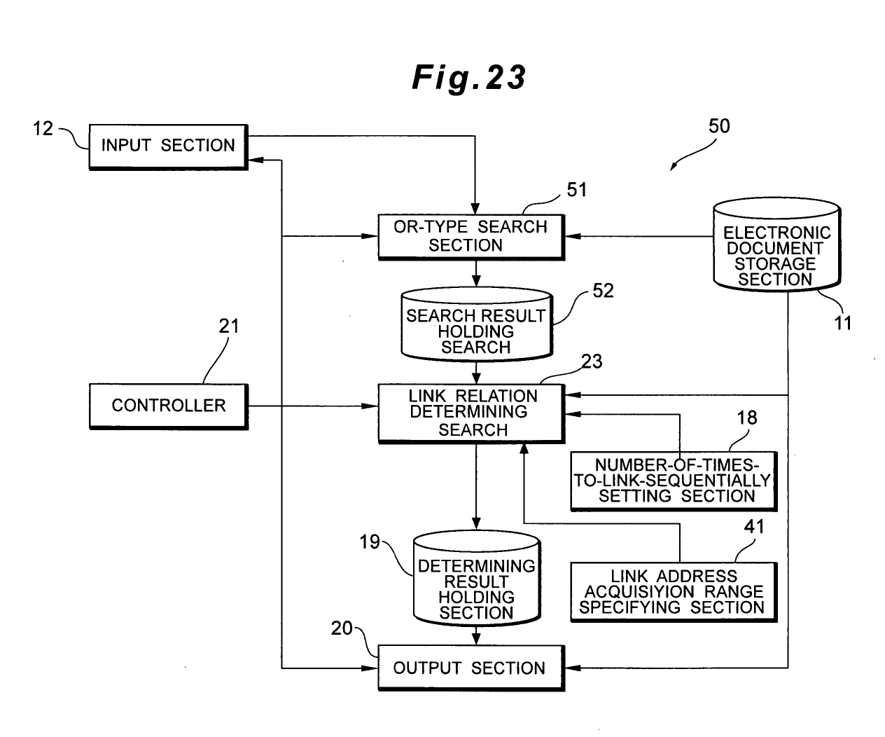

The electronic document searching apparatus 50 of embodiment 4, as shown in FIG. 23, as in embodiment 3, comprises the electronic document storage section 11; the input section 12; the number-of-times-to-link-sequentially setting section 18; the determining result holding section 19; the output section 20; the controller 21; and a link relation determining section 23 instead of the link relation determining section 22 of embodiment 3. The electronic document searching apparatus 50 further comprises the OR-type search section 51 and the search result holding section 52.

The OR-type search section 51 searches for electronic documents including at least one or more of a plurality of character-strings acquired by the input section 12.

The search result holding section 52 holds the addresses of the electronic documents searched by the OR-type search section 51.

The link address acquisition range specifying section 41 of embodiment 4 analyzes electronic documents addressed by the addresses held in the search result holding section 52 and specifies a range for acquiring link addresses based on the location of the search character-string, the number of characters, the number and contents of tags of the structured document, the document structure, and the like.

The link relation determining section 23 acquires link addresses from the acquiring range specified by the link address acquisition range specifying section 41, and follows the acquired link addresses and determines whether all the search character-strings are included in either of electronic documents that are respectively at the start and end points which are associated within the number of times to link sequentially set by the number-of-times-to-link-sequentially setting section 18.

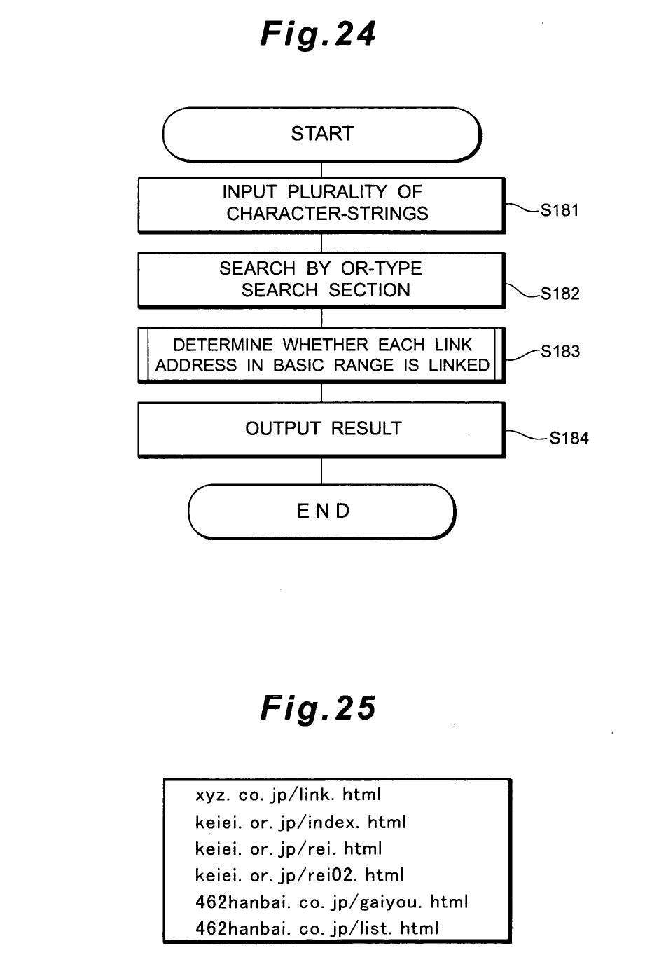

Next, the operation of the electronic document searching apparatus 50 will be explained with reference to the flow chart of FIG. 24.

The electronic document group 100 held in the electronic document storage section 11 has the contents as shown in FIG. 2. Under these conditions, the input section 12 acquires “management strategy” and “Alpha Electric” as search character-strings (step S181).

The OR-type search section 51 searches for electronic documents including at least one of the character-strings acquired by the input section 12 (step S182). In FIG. 25, the search result holding section 52 holds as link origin addresses the addresses of the electronic documents searched for by the OR-type search section 51.

For each of the link origin addresses held in the search result holding section 52, the link relation determining section 23 acquires link addresses from the acquiring range specified by the link address acquisition range specifying section 41, follows the acquired link addresses, and determines whether all the search character-strings are included in either of electronic documents that are respectively at the link origin address and at the end point, a to-link-to address, which are associated within the number of times to link sequentially set by the number-of-times-to-link-sequentially setting section 18 (step S183).

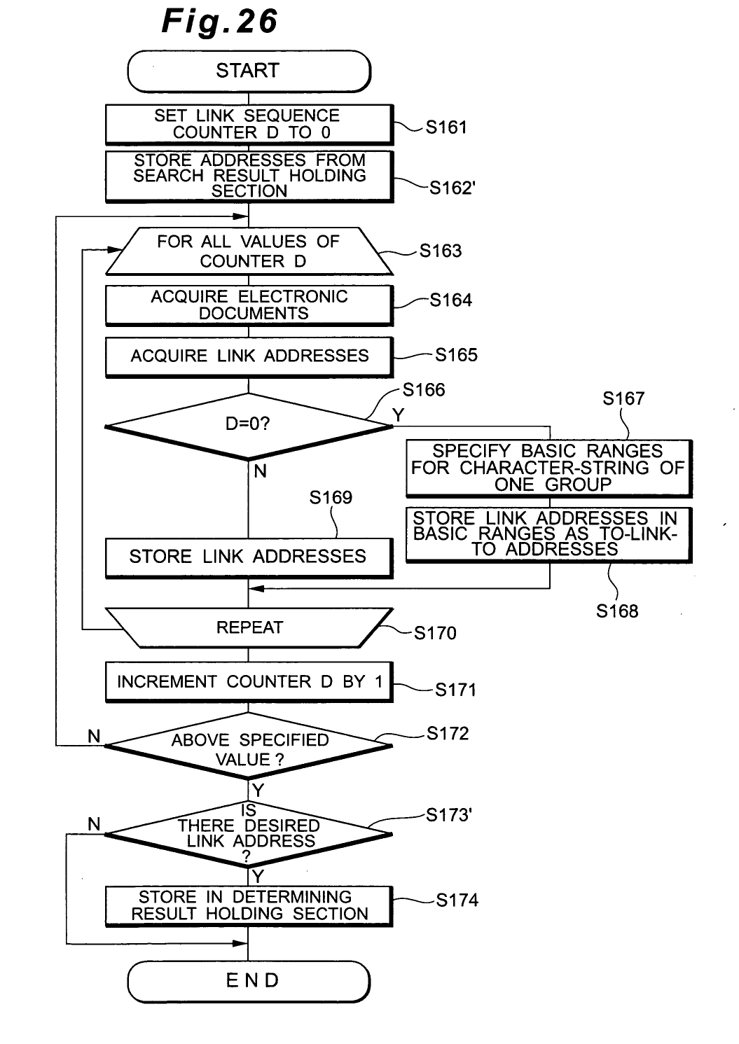

The flow chart of FIG. 26 shows the operation of the link relation determining section 23, which is the same as the operation of the link relation determining section 22 of embodiment 3 shown by the flow chart of FIG. 20 except the processes of step S162′ and S173′ of the former flow chart. A description of the same operation part is omitted.

The link relation determining section 23 comprises a link-sequence counter and a link management information table as in the above embodiment s, and the number-of-times-to-link-sequentially setting section 18 has set the predetermined number of times to link sequentially at two.

The link relation determining section 23 initially sets the link-sequence counter to zero (step S161). Next, the addresses held in the search result holding section 52 are stored as link origin addresses in the link management information table (step S162′).

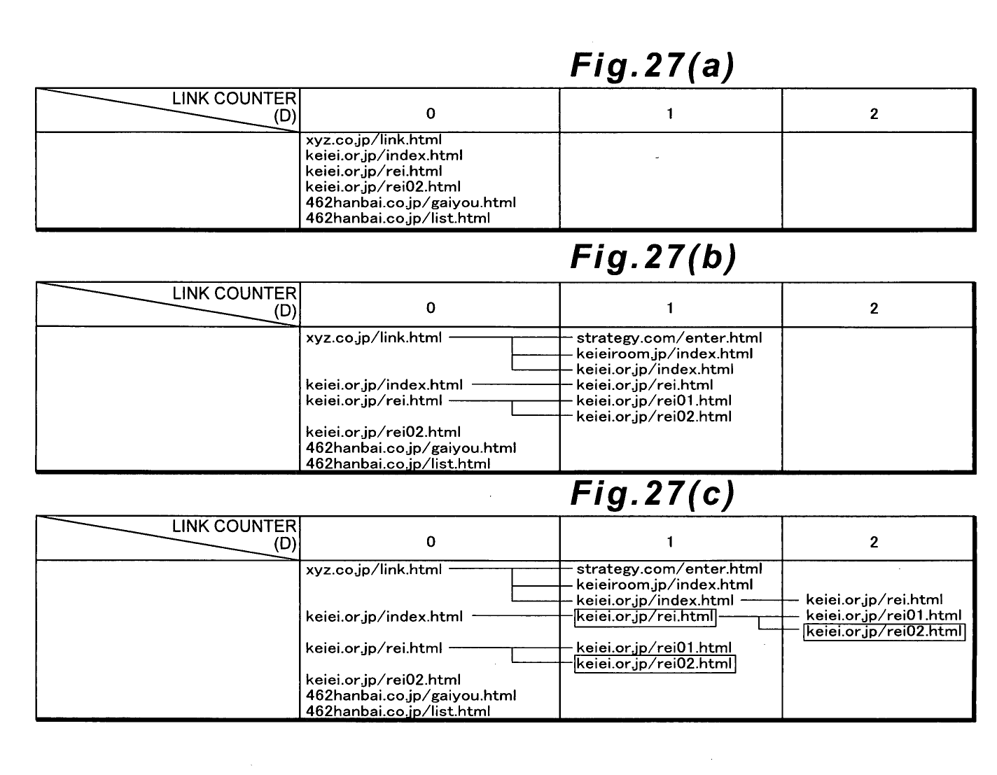

The contents of the link management information table having the link origin addresses for the combination numbered 1 in FIG. 3 stored are shown in FIG. 27(a).

Processes up to later step S172, where it is determined whether the value of the link-sequence counter is above the number set by the number-of-times-to-link-sequentially setting section 18, are the same as those of the operation of the link relation determining section 22 shown by the flow chart of FIG. 20. Hence, the description of steps S163 to S172 is omitted.

The link origin addresses in the search result holding section 52 are stored in the link management information table. The steps S163 through S172 are repeated. As the link-sequence counter increases from 0 to 1 to 2, the contents of the link management information table change, which changes are shown in FIGS. 27(a), 27(b), and 27(c).

When the value of the incremented link-sequence counter becomes greater than the value set by the number-of-times-to-link-sequentially setting section 18, having followed link addresses acquired from the acquiring range specified by the link address acquisition range specifying section 41, it is determined, for each link origin address, whether all the search character-strings are included in the electronic document addressed by the link origin address and the electronic document addressed by the to-link-to address at the end of the link sequence (step S173′).

In FIG. 27(c), the to-link-to addresses of the link sequences for which all the search character-strings are included in the electronic documents addressed by the link origin address and the to-link-to address are encircled by squares respectively.

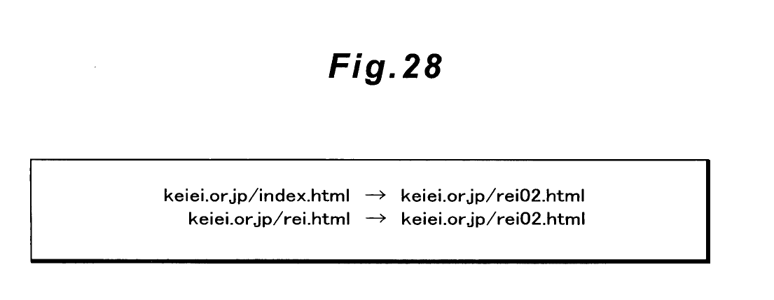

When all the search character-strings are included in the electronic documents addressed by the link origin address and the to-link-to address, pairs of such a to-link-to address and link origin address are stored in the determining result holding section 19 as shown in FIG. 28 (step S174).

Referring back to the flow chart of FIG. 24, the link origin addresses and to-link-to addresses held in the determining result holding section 19 are output by the output section 20 (step S184).

As described above, according to the electronic document searching apparatus of embodiment 4, because of searching collectively for electronic documents including at least one or more of search character-strings acquired, the entire search can be executed by searching a minimum number of times. Thus, even with a slow-speed search apparatus or a search apparatus having restrictions on the number of times to search, it is possible to efficiently search for desired electronic documents.

The usage of the electronic document searching apparatuses of the present invention will be explained.

An electronic document searching apparatus of the present invention may have the combination of the characteristic configurations of the previously described embodiments 1 and 2. For example, it may be so configured that, after adding to one group the broad terms of search character-strings of the other group, the link relation determining section 17 follows only internal link addresses in the electronic document addressed by each link origin address and determines whether a to-link-to address is associated.

Without the grouping section 13 automatically grouping search character-strings, for example, a user may group search character-strings or arbitrarily select a combination to be processed from combinations produced in the grouping.

While in embodiment 2, for “Alpha Electric”, “electric apparatus” is added as an additional search character-string to search character-strings, the broad term of “electric apparatus”, “enterprise”, may be added as an additional search character-string.

In embodiment 2, when there are several search character-strings which each have a broad term, any one or more broad terms in various combinations may be added as additional search character-strings to the search character-strings.

While in embodiment 3 the description was made using HTML-format structured documents, this embodiment can be applied to any structured documents, not being limited to the HTML format.

While in embodiment 3 a range for acquiring link addresses is specified based on the location of the search character-string, the number of characters, the number and contents of tags of the structured document, the document structure, and the like, not being limited to this, the range for acquiring link addresses may be, for example, a portion from a search character-string to an anchor, if the number of characters is within a predetermined range, or may be specified based on the number of sentences or tags instead of the number of characters.

In embodiment 4, if the number of search character-strings is N, the search results with respect to each of the N search character-strings are added up, then the added result, as a logical sum, is stored in the search result holding section 52.

According to an electronic document searching apparatus of the present invention, a plurality of search character-strings are divided into two groups, and by determining whether it is linked within a predetermined number of links from the address of an electronic document including a search character-string of one group to the address of an electronic document including a search character-string of the other group, the addresses of electronic documents related to the search character-strings are acquired based on the association between the addresses. Hence, without a need for providing a large storage area for holding electronic documents to link to read in collectively, desired electronic documents can be searched for, and also electronic documents where there is a relationship between a plurality of search character-strings can be searched for appropriately.

Furthermore, according to another electronic document searching apparatus of the present invention, the following operations are performed. That is: to search an electronic document which includes at least one or more character-strings; to hold a address, as a link origin address, which corresponds to the searched electronic document; to search another electronic document via search of predetermined times, beginning from the link origin address; to decide a address, as a to-link-to address, which corresponds to the another searched electronic document; to judge whether all the plurality of character-strings are totally included in either of the above two electronic documents that respectively corresponds to the link origin address and the to-link-to address; then to obtain a desired electronic document which relates to all the character-strings.

Thereby, without a need for providing a large storage area for holding electronic documents to link to read in collectively, desired electronic documents can be searched for, and also electronic documents where there is a relationship between search character-strings can be searched for appropriately.

Although the preferred embodiments of the present invention have been described in detail, it should be understood that various changes, substitutions and alterations can be made therein without departing from the spirit and scope of the invention as defined by the appended claims.

What is claimed is:

1. An electronic document searching apparatus which searches an electronic document storage section holding a plurality of electronic documents indicating link addresses of objects associated thereto for desired electronic documents based on search character-strings different from each other, said apparatus comprising:
a link origin address holding section that searches said electronic document storage section for electronic documents including a first search character-string and holds addresses of the electronic documents as link origin addresses;
a to-link-to address holding section that searches said electronic document storage section for electronic documents including a second search character-string and holds addresses of the electronic documents as to-link-to addresses; and
a link relation determining section that follows link addresses indicated in an electronic document addressed by said each link origin address held in said link origin address holding section and determines, for each said link address, whether at least one of said to-link-to addresses held in said to-link-to address holding section is associated within a predetermined number of times to link sequentially.

2. An electronic document searching apparatus which searches an electronic document storage section holding a plurality of electronic documents indicating link addresses of objects associated thereto for desired electronic documents based on search character-strings different from each other, said apparatus comprising:
a search address holding section that searches said electronic document storage section for a plurality of electronic documents including at least one of said search character-strings and holds addresses of the electronic documents as link origin addresses; and
a link relation determining section that follows link addresses indicated in an electronic document addressed by each said link origin address held in said search address holding section within a predetermined number of times to link sequentially and determines, for each said link address, whether all said search character-strings are included in an electronic document addressed by a to-link-to address to link to and the electronic document addressed by said link origin address.

3. The electronic document searching apparatus according to claim 1, further comprising:
an output section that outputs addresses of electronic documents including said search character-strings as a search result based on determining results of said link relation determining section.

4. The electronic document searching apparatus according to claim 1, further comprising:
a grouping section that divides a plurality of said search character-strings into a group which includes at least one said first search character-string and a group which includes at least one said second search character-string.

5. The electronic document searching apparatus according to claim 1, further comprising:
a thesaurus dictionary that has classified and systematized character-strings stored; and
a search character-string adding section that, referring to said thesaurus dictionary, acquires systematized character-strings corresponding to said search character-strings as additional search character-strings and adds the additional search character-strings to said search character-strings.

6. The electronic document searching apparatus according to claim 1, wherein said link relation determining section identifies whether each of link addresses indicated in an electronic document addressed by said each link origin address is associated internally or externally, and follows each link address found to be in an internal link relationship to determine whether at least one of said to-link-to addresses is associated within a predetermined number of times to link sequentially.

7. The electronic document searching apparatus according to claim 1, further comprising:
a link address acquisition range specifying section that specifies a range for acquiring a link address to be followed by said link relation determining section, based on a location of each search character-string in an electronic document addressed by each said link origin address.

8. The electronic document searching apparatus according to claim 7, wherein said link address acquisition range specifying section specifies a range for acquiring a link address based on one, or a combination, of the number of tags for a structured document, and a location and the number of characters of each search character-string included in an electronic document addressed by each said link origin address.

9. The electronic document searching apparatus according to claim 7, wherein said link address acquisition range specifying section specifies a range for acquiring a link address based on a location of each search character-string included in an electronic document addressed by each said link origin address and on the document structure of said electronic document.

10. The electronic document searching apparatus according to claim 2, further comprising:
an output section that outputs addresses of electronic documents including said search character-strings as a search result based on determining results of said link relation determining section.

11. The electronic document searching apparatus according to claim 2, wherein said link relation determining section identifies whether each of link addresses indicated in an electronic document addressed by said each link origin address is associated internally or externally, and follows each link address found to be in an internal link relationship to determine whether at least one of said to-link-to addresses is associated within a predetermined number of times to link sequentially.

12. The electronic document searching apparatus according to claim 2, further comprising:
a link address acquisition range specifying section that specifies a range for acquiring a link address to be followed by said link relation determining section, based on a location of each search character-string in an electronic document addressed by each said link origin address.

13. The electronic document searching apparatus according to claim 12, wherein said link address acquisition range specifying section specifies a range for acquiring a link address based on one, or a combination, of the number of tags for a structured document, and a location and the number of characters of each search character-string included in an electronic document addressed by each said link origin address.

14. The electronic document searching apparatus according to claim 12, wherein said link address acquisition range specifying section specifies a range for acquiring a link address based on a location of each search character-string included in an electronic document addressed by each said link origin address and on the document structure of said electronic document.
